(19) United States
(12) Patent Application Publication
(10) Pub. No.: US 2026/0142498 A1
(43) Pub. Date: May 21, 2026

(54) COIL GROUP AND WIRELESS POWER SUPPLY SYSTEM

(71) Applicant: DENSO CORPORATION, Kariya-city (JP)

(72) Inventors: Kazuhiro UDA, Kariya-city (JP); Shimpei TAKITA, Kariya-city (JP); Eisuke TAKAHASHI, Kariya-city (JP); Masaya TAKAHASHI, Kariya-city (JP)

(73) Assignee: DENSO CORPORATION, Kariya-city (JP)

(21) Appl. No.: 19/446,003

(22) Filed: Jan. 12, 2026

Related U.S. Application Data
(63) Continuation of application No. PCT/JP2024/023345, filed on Jun. 27, 2024.

(30) Foreign Application Priority Data
Jul. 11, 2023 (JP) 2023-113489

(51) Int. Cl. H02J 50/12; B60L 53/122; H02J 50/40

(52) U.S. Cl. CPC H02J 50/12; B60L 53/122; H02J 50/402

(57) ABSTRACT

A coil group includes a plurality of primary coils and a secondary coil. When a first coupling coefficient is ka, the first coupling coefficient ka being a coupling coefficient between a target primary coil and the secondary coil in a first position, and a local maximum coupling coefficient sum is kba, the local maximum coupling coefficient sum being a coupling coefficient sum at a local maximum position in a second position in which the coupling coefficient sum is a local maximum, the coupling coefficient sum being a sum of the coupling coefficients between the primary coils of the first primary coil group and the secondary coil, the first coupling coefficient ka and the local maximum coupling coefficient sum kba satisfy D1<½×Max(ka, kba), where D1 is a difference between ka and kba, and Max(ka, kba) is a maximum value between ka and kba.

### CROSS-REFERENCE TO RELATED APPLICATIONS

The present application is a continuation application of International Application No. PCT/JP2024/023345, filed on Jun. 27, 2024, which claims priority to Japanese Patent Application No. 2023-113489, filed on Jul. 11, 2023. The contents of these applications are incorporated herein by reference in their entirety.

### BACKGROUND

The present disclosure relates to a coil group and a wireless power supply system.

A technology is known in which charging coils for wireless power supply are arranged in a stacked manner, thereby allowing a vehicle pad for power reception to receive power from a plurality of charging coils.

### SUMMARY

One aspect of the present disclosure provides a coil group including: a plurality of primary coils; and a secondary coil of which a relative position to the plurality of primary coils is able to be changed. The plurality of primary coils are arranged in a planar shape. The secondary coil is capable of receiving power without contact from at least one of the plurality of primary coils while changing the relative position. The secondary coil is able to be displaced between a first position in which a center axis of the secondary coil coincides with a center axis of one target primary coil among the plurality of primary coils and a second position in which the center axis of the secondary coil does not coincide with the center axis of any of the plurality of primary coils, and power is able to be received from a primary coil group including at least two of the plurality of primary coils. When a first coupling coefficient is ka, the first coupling coefficient ka being a coupling coefficient between the target primary coil and the secondary coil in the first position, and a local maximum coupling coefficient sum is kba, the local maximum coupling coefficient sum being a coupling coefficient sum at a local maximum position in the second position in which the coupling coefficient sum is a local maximum, the coupling coefficient sum being a sum of the coupling coefficients between the primary coils of the first primary coil group and the secondary coil,
the first coupling coefficient ka and the local maximum coupling coefficient sum kba satisfy expression (1), below,

$$D 1 < 1 / 2 \times Max ( ka , kba ) \qquad ( 1 )$$

where D1 is a difference between the first coupling coefficient ka and the local maximum coupling coefficient sum kba, and Max(ka, kba) is a maximum value between the first coupling coefficient ka and the local maximum coupling coefficient sum kba.

### BRIEF DESCRIPTION OF THE DRAWINGS

In the accompanying drawings:

FIG. 1 is an overall configuration diagram of a wireless power supply system according to a first embodiment;

FIG. 2 is a circuit diagram of the wireless power supply system according to the first embodiment;

FIG. 3 is a flowchart of a power supply sequence;

FIG. 4 is a diagram for explaining an arrangement mode of power transmission coils and a power reception coil according to the first embodiment;

FIG. 5 is a diagram showing correspondence between movement of the power reception coil and the power transmission coil supplying power;

FIG. 6 is a flowchart of a design process;

FIG. 7 is a diagram for explaining steps in the design process;

FIG. 8 is a diagram for explaining another aspect the arrangement mode of the power reception coil and the power transmission coils;

FIG. 9 is a circuit diagram of a wireless power supply system according to a second embodiment;

FIG. 10 is a circuit diagram of a wireless power supply system according to a third embodiment;

FIG. 11 is a circuit diagram of a wireless power supply system according to a fourth embodiment;

FIG. 12 is a circuit diagram of a wireless power supply system according to a fifth embodiment;

FIG. 13 is a circuit diagram of a wireless power supply system according to a sixth embodiment; and

FIG. 14 is a diagram for explaining another aspect of the arrangement mode of the power transmission coil.

### DESCRIPTION OF THE EMBODIMENTS

JP 2017-521984 A discloses a technology in which charging coils for wireless power supply are arranged in a stacked manner, thereby allowing a vehicle pad for power reception to receive power from a plurality of charging coils.

However, physical size in a height direction increases when the charging coils are arranged in the stacked manner.

The present disclosure can be implemented according to the following exemplary embodiments.

A first exemplary embodiment of the present disclosure provides a coil group that includes a plurality of primary coils, and a secondary coil of which a relative position to the plurality of primary coils is able to be changed. The plurality of primary coils are arranged in a planar shape. The secondary coil is capable of receiving power without contact from at least one of the plurality of primary coils while changing the relative position. The secondary coil is able to be displaced between a first position in which a center axis of the secondary coil coincides with a center axis of one target primary coil among the plurality of primary coils, and a second position in which the center axis of the secondary coil does not coincide with the center axis of any of the plurality of primary coils and power is able to be received from a primary coil group including at least two of the plurality of primary coils.

When a first coupling coefficient is ka, the first coupling coefficient ka being a coupling coefficient between the target primary coil and the secondary coil in the first position is ka, and a local maximum coupling coefficient sum is kba, the local maximum coupling coefficient sum kba being a coupling coefficient sum at a local maximum position in the second position in which the coupling coefficient sum is a local maximum, the coupling coefficient sum being a sum of the coupling coefficients between the primary coils of the first primary coil group and the secondary coil, the first coupling coefficient ka and the local maximum coupling coefficient sum kba satisfy expression (1), below,

$$D 1 < 1 / 2 \times Max ( ka , kba ) \qquad ( 1 )$$

where D1 is a difference between the first coupling coefficient ka and the local maximum coupling coefficient sum kba, and Max(ka, kba) is a maximum value between the first coupling coefficient ka and the local maximum coupling coefficient sum kba.

According to the first exemplary embodiment, the plurality of power transmission coils are arranged in a planar shape. Therefore, the power reception coil can receive power from the plurality of power transmission coils without physical size in a height direction of the plurality of primary coils being increased. In addition, as a result of D1<½×Max(ka, kba) being satisfied, when the power reception coil receives power while changing the relative position to the power transmission coil, a variation range of variation in power supply efficiency accompanying movement can be reduced.

A second exemplary embodiment of the present disclosure provides a coil group that includes a plurality of primary coils, and a secondary coil of which a relative position to the plurality of primary coils is able to be changed. The plurality of primary coils are arranged in a planar shape. The secondary coil is capable of receiving power without contact from at least one of the plurality of primary coils while changing the relative position. The secondary coil is able to be displaced between a first position in which a center axis of the secondary coil coincides with a center axis of one target primary coil among the plurality of primary coils, and a second position in which the center axis of the secondary coil does not coincide with the center axis of any of the plurality of primary coils and power is able to be received from a primary coil group including at least two of the plurality of primary coils.

When a first coupling coefficient is ka, the first coupling coefficient being a coupling coefficient between the target primary coil and the secondary coil in the first position is ka, and a specific coupling coefficient sum is kbt, the specific coupling coefficient sum being a coupling coefficient sum in a specific second position in the second position in which (i) at least any one of the coupling coefficients between the primary coils in the primary coil group and the secondary coil in the second position that are the plurality of coupling coefficients corresponding to the plurality of primary coils included in the primary coil group and (ii) a coupling coefficient sum that is a sum of the coupling coefficients of the primary coils in the primary coil group and the secondary coil coincide, the first coupling coefficient ka and the specific coupling coefficient sum kbt satisfy expression (6), below,

$$D 2 < 1 / 2 \times Max ( ka , kba ) \qquad ( 6 )$$

where D2 is a difference between the first coupling coefficient ka and the specific coupling coefficient sum kbt, and Max(ka, kba) is a maximum value between the first coupling coefficient ka and a local maximum coupling coefficient sum kba that is a local maximum of the coupling coefficient sum.

According to the second exemplary embodiment, the plurality of power transmission coils are arranged in a planar shape. Therefore, the power reception coil can receive power from the plurality of power transmission coils without physical size in a height direction of the plurality of primary coils being increased. In addition, as a result of D2<½×Max(ka, kba) being satisfied, when the power reception coil receives power while changing the relative position to the power transmission coil, a variation range of variation in power supply efficiency accompanying movement can be reduced.

The above-described exemplary embodiments of the present disclosure will be further clarified through the detailed description herebelow, with reference to the accompanying drawings.

### A. First Embodiment

### A1. Configuration of a Wireless Power Supply System

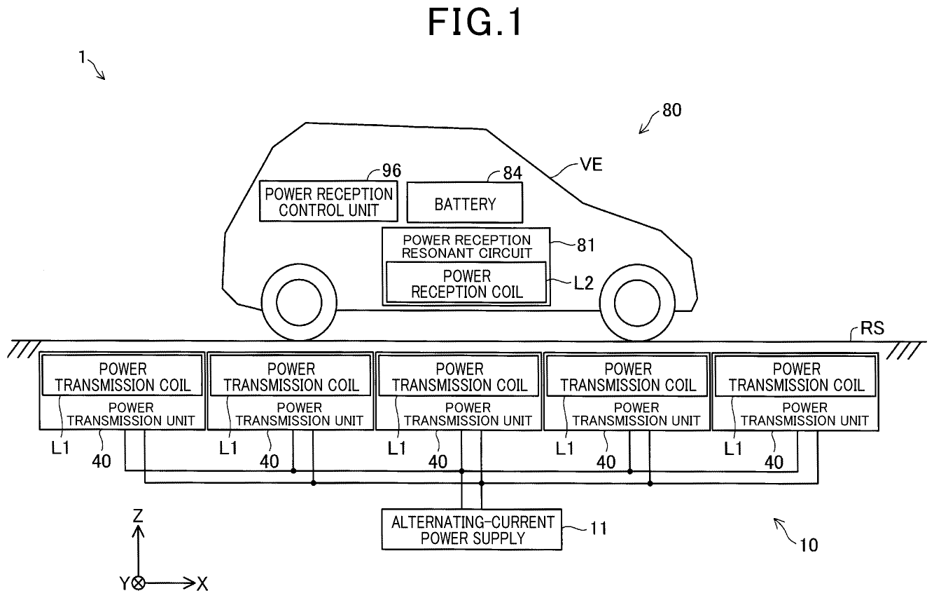

As shown in FIG. 1, a wireless power supply system 1 includes a wireless power supply apparatus 10 and a power reception apparatus 80. According to a present embodiment, the wireless power supply apparatus 10 is embedded under a road RS. The power reception apparatus 80 is mounted in a vehicle VE serving as a moving body that travels on the road RS. While the vehicle VE is traveling, the power reception apparatus 80 is supplied power from the wireless power supply apparatus 10. Here, the term “while traveling” includes a case in which the vehicle VE is moving and a case in which the vehicle VE is stopped, such as while waiting for a traffic light to change. For example, the vehicle VE may be configured as an electric car or hybrid car. FIG. 1 shows an X-axis, a Y-axis, and a Z-axis that are orthogonal to one another.

The wireless power supply apparatus 10 has a power transmission unit 40 that has a power transmission coil L1 serving as a primary coil and an alternating-current power supply 11 that supplies power to the power transmission unit 40. The alternating-current power supply 11 supplies alternating-current power at an operating frequency prescribed in advance to a plurality of power transmission units 40. The plurality of power transmission coils L1 are arrayed along an extension direction of the road RS and a direction intersecting the extension direction. The extension direction of the road RS is an X-axis direction. A direction in which the power transmission coil L1 and the power reception coil L2 oppose each other is a Z-axis direction. The power transmission coils L1 are arranged along an XY plane, as described in detail hereafter.

Here, the moving body in which the power reception apparatus 80 is mounted is not limited to the vehicle VE that travels on the road RS and, for example, may be an automated guided vehicle (AGV) or a traveling robot. In addition, the power transmission unit 40 may be set in a sidewalk or a parking lot adjacent to the road RS, or on a path traveled by an AGV, rather than under the road RS.

The power reception apparatus 80 includes a battery 84 serving as a power storage apparatus, a power reception resonant circuit 81 having a power reception coil L2 serving as a secondary coil, and a power reception-side control unit 96. The power reception coil L2 is capable of being magnetically coupled with the power transmission coil L1. According to the present embodiment, the power reception coil L2 is provided on an underside of the vehicle VE, in a position opposing the power transmission coil L1.

Power received by the power reception coil L2 is supplied to the battery 84. The battery 84 is a secondary battery charged by direct-current power that is supplied. The power charged in the battery 84 is used for drive power for travel and the like.

The power reception-side control unit 96 controls each section, such as the power reception resonant circuit 81, inside the power reception apparatus 80. The power reception-side control unit 96 is implemented to include an engine control unit (ECU). Here, the ECU may be implemented by a single microcontroller or may include a plurality of microcontrollers.

### A2. Circuit Configuration of the Wireless Power Supply System

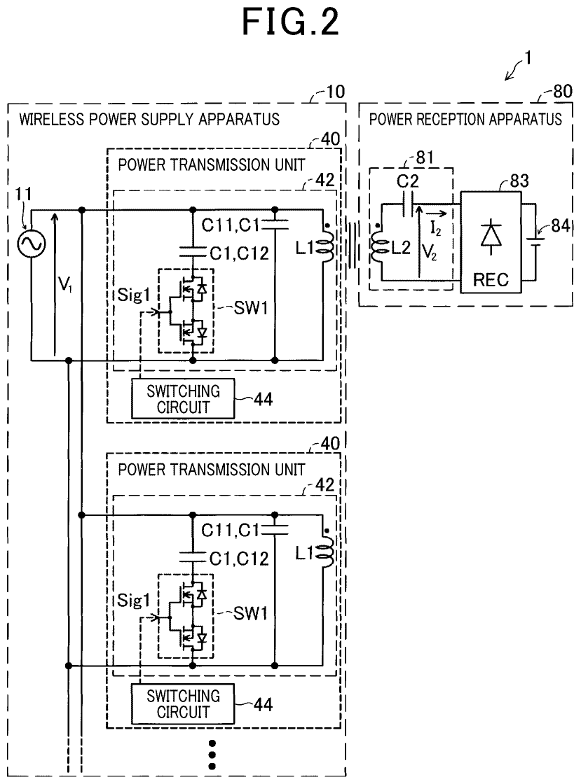

As shown in FIG. 2, in addition to the above-described configuration, the power transmission unit 40 has a power transmission resonant circuit 42 and a switching circuit 44. The power transmission resonant circuit 42 has the power transmission coil L1, a power transmission capacitor C1 serving as a primary capacitor, and a first switch SW1. The power transmission capacitor C1 includes a first power transmission capacitor C11 and a second power transmission capacitor C12. The first switch SW1 is a bidirectional switch to which respective source terminals of two field effect transistors (FETs) are connected. A switching signal Sig1 output from the switching circuit 44 is input to gate terminals of the two FETs. An on/off state of the first switch SW1 is thereby controlled.

The first power transmission capacitor C11 is connected in series to the power transmission coil L1. The first switch SW1 is connected in series to the second power transmission capacitor C12. A connection body of the second power transmission capacitor C12 and the first switch SW1 is connected in parallel to the power transmission coil L1. A capacitance value of the power transmission resonant circuit 42 that is a parallel resonant circuit is switched by the on/off state of the first switch SW1 being switched.

The switching circuit 44 switches a state of the power transmission resonant circuit 42 between a power supply state in which power is supplied from the power transmission coil L1 to the power reception coil L2 and a non-power supply state in which power is not supplied from the power transmission coil L1 to the power reception coil L2 According to the present embodiment, the switching circuit 44 switches the state of the power transmission resonant circuit 42 between a resonant state and a non-resonant state by switching the first switch SW1 between the on state and the off state. As described hereafter, power is supplied from the power transmission coil L1 to the power reception coil L2 when the power transmission resonant circuit 42 is in the resonant state. In addition, power is not supplied from the power transmission coil L1 to the power reception coil L2 when the power transmission resonant circuit 42 is in the non-resonant state. That is, the switching circuit 44 sets the power transmission resonant circuit 42 to the power supply state by setting the power transmission resonant circuit 42 to the resonant state. The switching circuit 44 sets the power transmission resonant circuit 42 to the non-power supply state by setting the power transmission resonant circuit 42 to the non-resonant state.

When setting the power transmission resonant circuit 42 to the non-resonant state, the switching circuit 44 sets the first switch SW1 to the off state. When setting the power transmission resonant circuit 42 to the resonant state, the switching circuit 44 sets the first switch SW1 to the on state. When the power transmission coil L1 and the power reception coil L2 are magnetically coupled, a capacitance value of the power transmission capacitor C1, that is, a combined capacitance of the first power transmission capacitor C11 and the second power transmission capacitor C12 is set to a value in which the power transmission resonant circuit 42 enters the resonant state at the operating frequency. When the first switch SW1 is set to the off state, a resonant frequency of the power transmission resonant circuit 42 shifts from the operating frequency, and the power transmission resonant circuit 42 thereby enters the non-resonant state.

The power reception apparatus 80 includes a power reception resonant circuit 81, a rectifier circuit 83, and the battery 84. The power reception resonant circuit 81 has a power reception coil L2 serving as a secondary coil, and a power reception capacitor C2 serving as a secondary capacitor connected in series to the power reception coil L2. The rectifier circuit 83 rectifies alternating-current power received by the power reception resonant circuit 81 and supplies rectified direct-current power to the battery 84.

When the power transmission coil L1 and the power reception coil L2 are magnetically coupled, the resonant frequency of the power transmission resonant circuit 42 and the resonant frequency of the power reception resonant circuit 81 are set to be substantially the same. As a result, power can be supplied to the power reception apparatus 80 without contact through resonant coupling of magnetic fields of the power transmission coil L1 and the power reception coil L2. As described above, the direct-current power output from the power reception resonant circuit 81 is rectified by the rectifier circuit 83 and supplied to the battery 84.

According to the present embodiment, a primary side is a parallel resonant circuit, a secondary side is a series resonant circuit, and so-called P-S wireless power supply is performed. According to the present embodiment, a capacitance value of the power transmission capacitor C1 is C1, self-inductance of the power transmission coil L1 is L1, a capacitance value of the power reception capacitor C2 is C2, self-inductance of the power reception coil L2 is L2, and an angular frequency of the alternating-current power output from the alternating-current power source 11 is ω. The capacitance value C1 is set to satisfy expression (a1), below, and the capacitance value C2 is set to satisfy expression (a2), below. In this case, a secondary voltage V2 is ideally expressed by expression (a3), below, using a primary voltage V1.

$$C 1 = 1 / ( ω2 \cdot L 1 ) \qquad ( a1 )$$

$$C 2 = 1 / ( ω2 \cdot L 2 ( 1 - k 2 ) ) \qquad ( a2 )$$

$${V}_{2} = \frac{k}{1} \frac{1}{\sqrt{\frac{{L}_{1}}{{L}_{2}}}} \qquad ( a3 )$$

As shown in expression (a3), a coupling coefficient k between the power transmission coil L1 and the power reception coil L2, and the secondary voltage V2 have a positive correlation. Therefore, the power output to the battery 84 can be increased by the coupling coefficient k being increased.

### A3. Overview of a Power Supply Sequence

A relative position of the power reception coil L2 to the plurality of power transmission coils L1 can be changed. The power transmission coils L1 are arranged along the XY plane. The power reception coil L2 receives power supply without contact from a nearest power transmission coil L1. The power transmission unit 40 is set to either of a standby state and a power supply state. Specifically, when setting the standby state, the switching circuit 44 sets the first switch SW1 to the off state and sets the power transmission resonant circuit 42 to the non-resonant state. In contrast, when setting the power supply state, the switching circuit 44 sets the first switch SW1 to the on state and sets the power transmission resonant circuit 42 to the resonant state. A standby current flowing to the power transmission coil L1 in the standby state is smaller than a power supply current flowing to the power transmission coil L1 in the power supply state.

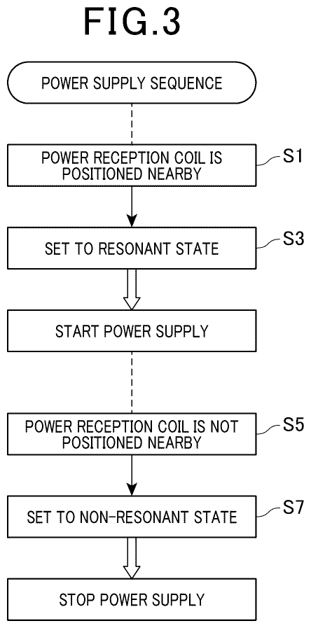

A power supply sequence will be described with reference to FIG. 3. The power transmission unit 40 is set to the standby state at startup.

In the standby state, the power transmission unit 40 sends the standby current to the power transmission coil L1 and generates magnetic flux from the power transmission coil L1. When the power reception coil L2 approaches the power transmission coil L1, the power reception apparatus 80 detects the magnetic flux generated by the power transmission coil L1 using a secondary-side detection circuit (not shown). When the magnetic flux generated by the power transmission coil L1 is detected, the power reception apparatus 80 generates a starting magnetic flux. Specifically, the power reception apparatus 80 applies alternating-current power to a magnetic flux generation coil (not shown). As a result, the magnetic flux generation coil generates a magnetic flux.

When the magnetic flux generated by the power reception apparatus 80 is detected by a magnetic sensor (not shown), the power transmission unit 40 determines that the power reception coil L2 is positioned near the power transmission coil L1. When determined that the power reception coil L2 is positioned near the power transmission coil L1 at step S1, at step S3, the power transmission resonant circuit 42 is set to the resonant state. Specifically, the switching circuit 44 switches the first switch SW1 from the off state to the on state using the switching signal Sig1. As a result, power can be supplied to the power reception coil L2 without contact through resonant coupling of the magnetic fields of the power transmission coil L1 and the power reception coil L2.

When the power reception coil L2 moves away from the power transmission coil L1, at step S5, the power transmission unit 40 determines that the power reception coil L2 is not positioned near the transmission coil L1 using a magnetic sensor (not shown). When determined that the power reception coil L2 is not positioned near the transmission coil L1 at step S5, at step S7, the switching circuit 44 sets the power transmission resonant circuit 42 to the non-resonant state. Specifically, the switching circuit 44 switches the first switch SW1 from the on state to the off state using the switching signal Sig1. As a result, power supply is stopped and the power transmission unit 40 is set to the standby state.

### A4. Arrangement Mode of the Power Transmission Coil and the Power Reception Coil

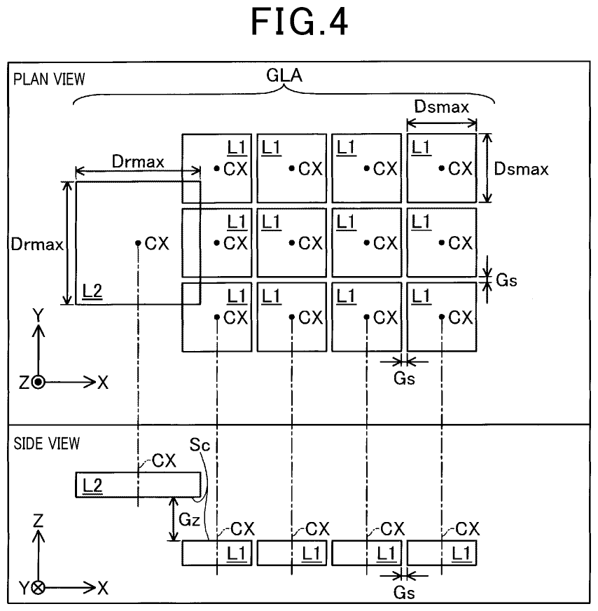

As shown in FIG. 4, a coil group GLA includes a plurality of power transmission coils L1 and the power reception coil L2. According to the present embodiment, the power transmission coil L1 and the power reception coil L2 are formed by a coil wire in which an insulating coating is formed on a conducting wire being wound in a spiral shape or a vortex shape around a coil center axis CX that is a center axis of the coil. As shown in a side view in FIG. 4, the power transmission coil L1 and the power reception coil L2 are arranged such that a coil plane Sc of the power transmission coil L1 perpendicular to the coil center axis CX is able to oppose a coil plane Sc of the power reception coil L2. Here, the power transmission coil L1 and the power reception coil L2 may be formed by a plurality of printed circuit boards on which C-shaped printed wiring is formed being stacked, and the printed wirings adjacent in the Z-axis direction being electrically connected to form a spiral-shaped wiring.

As shown in a plan view in FIG. 4, the plurality of power transmission coils L1 are arranged in a planar shape. Here, being arranged in a planar shape refers to the plurality of power transmission coils L1 being arrayed in a plurality of directions such that respective coil planes Cs run along a same plane or a same curve, such that the plurality of power transmission coils L1 do not overlap one another. Specifically, being arrayed in a plurality of directions means that the power transmission coils L1 are arrayed not only in the X-axis direction but also in the Y-axis direction. According to the present embodiment, the power transmission coils L1 are arranged at equal intervals. As described above, the power reception coil L2 is mounted in the vehicle VE. In addition, the power reception coil L2 is capable of receiving power without contact from at least one of the plurality of power transmission coils L1 while changing the relative position to the power transmission coils L1.

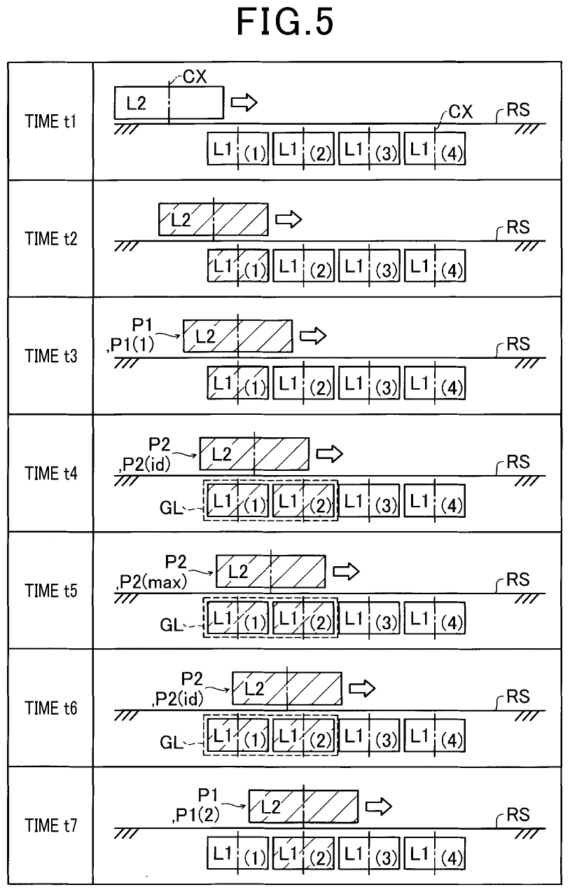

Power reception by the power reception coil L2 that is moving will be described with reference to FIG. 5. In FIG. 5, the power transmission coil L1 that is shaded is a coil that is supplying power without contact. In a similar manner, the power reception coil L2 that is shaded is a coil that is receiving power. The power reception coil L2 moves toward a right side of the paper.

At time t1 shown in FIG. 5, the power reception coil L2 approaching the power transmission coils L1 that are arrayed is shown. As shown at time t2 in FIG. 5, when the power reception coil L2 approaches the power transmission coil L1 at an end, wireless power supply is started. At time t3 in FIG. 5 as well, the power reception coil L2 is supplied power from the power transmission coil L1 at the end. As shown at time t4 in FIG. 5, as the vehicle advances and a distance between the power transmission coil L1 next to the power transmission coil L1 at the end and the power reception coil L2 becomes shorter, the power reception coil L2 also receives power from the power transmission coil L1 next to the power transmission coil L1 at the end.

Here, as shown at time t3 in FIG. 5, a position in which the coil center axis CX of the power reception coil L2 coincides with the coil center axis CX of any of the plurality of power transmission coils L1 is referred to as a first position P1. In the first position P1, the power transmission coil L1 of which the position of the coil center axis CX coincides with the coil center axis CX of the power reception coil L2 is also referred to as a target primary coil. In addition, as shown at time t4, time 5, and time 6 in FIG. 5, a position in which the coil center axis CX of the power reception coil L2 does not coincide with the coil center axis CX of any of the plurality of power transmission coils L1, and in which power can be received from a power transmission coil group GL serving as a primary coil group including at least two of the plurality of power transmission coils L1, is referred to as a second position P2. The power reception coil L2 is able to be displaced between the first position P1 and the second position P2.

According to the present embodiment, when a coupling coefficient k between the power transmission coil L1 and the power reception coil L2 in the first position P1 is a first coupling coefficient ka, and a coupling coefficient sum kb that is the coupling coefficient sum kb at a local maximum position P2(max) in the second position P2 in which the coupling coefficient sum kb becomes a local maximum, the coupling coefficient sum being a sum of the coupling coefficients k between the power transmission coils L1 of the power transmission coil group GL and the power reception coil L2 in the second position P2, is a local maximum coupling coefficient sum kba, the first coupling coefficient ka and the local maximum coupling coefficient sum kba satisfy expression (1), below. As a result, as described in detail hereafter, variation in the coupling coefficient k accompanying movement can be suppressed.

$$D 1 < 1 / 2 \times Max ( ka , kba ) \qquad ( 1 )$$

In expression (1), D1 is a difference between the first coupling coefficient ka and the local maximum coupling coefficient sum kba. In addition, in expression (1), Max(ka, kba) is a maximum value of the first coupling coefficient ka and the local maximum coupling coefficient sum kba.

Furthermore, according to the present embodiment, a specific coupling coefficient kbt that is the coupling coefficient sum kb at a specific second position P2(id) in the second position P2 in which (i) at least any one of the coupling coefficients k between the power transmission coils L1 in the power transmission coil group GL and the power reception coil L2 in the second position P2 that are the plurality of coupling coefficients corresponding to the plurality of power transmission coils L1 included in the power transmission coil group GL and (ii) the coupling coefficient sum kb that is a sum of the coupling coefficients k between the power transmission coils L1 of the power transmission coil group GL and the power reception coil L2 coincide satisfies expression (6), below. As a result, as described in detail hereafter, variations in the coupling coefficient k accompanying movement can be suppressed.

$$D 2 < 1 / 2 \times Max ( ka , kba ) \qquad ( 6 )$$

In expression (6), D2 is a difference between the first coupling coefficient ka and the specific coupling coefficient sum kbt.

Here, specifically, the wireless power supply system 1 is set such that respective sizes of the power transmission coil L1 and the power reception coil L2, spacing between the power transmission coils L1, and a distance in a height direction between the power transmission coil L1 and the power reception coil L2 satisfy expression (1) and expression (6), above.

The sizes of the power transmission coil L1 and the power reception coil L2 are, specifically, outer diameters of the respective coils. In the present specification, as shown in FIG. 4, the sizes of the power transmission coil L1 and the power reception coil L2 are each represented by a smallest rectangle that can enclose and be in contact with each coil. In addition, a maximum outer diameter of the coil is a length of a long side of the smallest rectangle enclosing and in contact with the coil. A minimum outer diameter of the coil is a length of a short side of the smallest rectangle enclosing and in contact with the coil. The smallest rectangle enclosing and in contact with the coil is parallel to the coil plane Sc. When the smallest rectangle enclosing and in contact with the coil is a square, the maximum outer diameter of the coil coincides with the minimum outer diameter. In the present specification, when the maximum outer diameter and the minimum outer diameter of the coil coincide, the size of the coil is expressed using the maximum outer diameter. According to the present embodiment, shapes of the power transmission coil L1 and the power reception coil L2 projected onto a coil plane are substantially square. In other words, the smallest rectangle enclosing and in contact with the coil is a square.

As shown in FIG. 4, a maximum outer diameter Drmax of the power reception coil L2 is greater than a maximum outer diameter Dsmax of the power transmission coil L1. A coil spacing Gs of the power transmission coils L1 on the XY plane and an inter-coil gap Gz that is a minimum distance between the coil plane Sc of the power transmission coil L1 and the coil plane Sc of the power reception coil L2 are set to values satisfying expression (1) and expression (6), above.

### A5. Design Process for the Power Transmission Coil and the Power Reception Coil

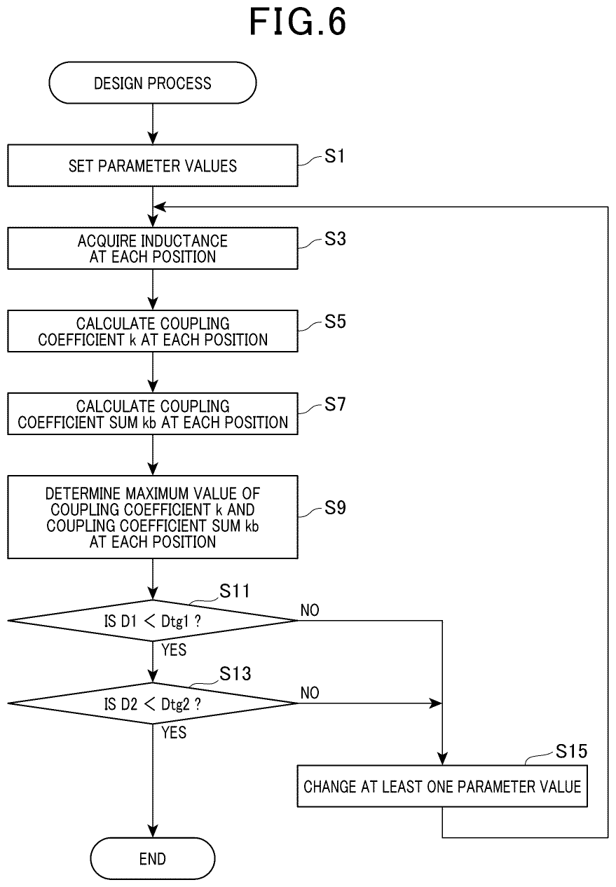

A design process for determining parameters of the power transmission coil L1 and the power reception coil L2 of the wireless power supply apparatus 10 to satisfy expression (1) and expression (6), above, will be described with reference to FIG. 6. Here, specifically, the parameters include the self-inductance of the power transmission coil L1, the self-inductance of the power reception coil L2, the maximum outer diameter Dsmax and a minimum outer diameter Dsmin of the power transmission coil L1, the maximum outer diameter Drmax and a minimum outer diameter Drmin of the power reception coil L2, the coil spacing Gs, the coil gap Gz, and the like.

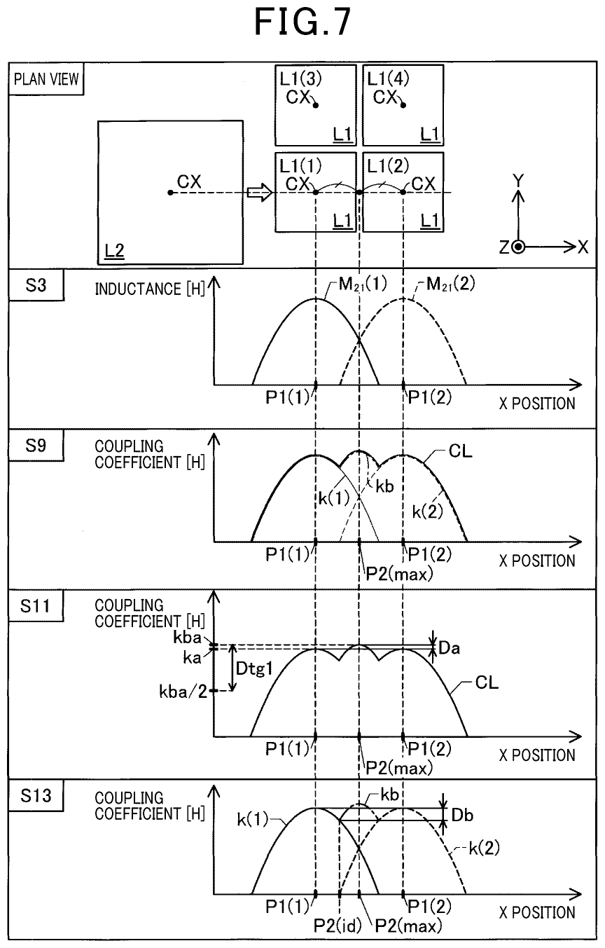

To facilitate understanding, as shown in a plan view in FIG. 7, a case in which four power transmission coils L1 are arrayed and the power reception coil L2 moves in an X-axis direction along a straight line connecting the coil center axes CX of the power transmission coils L1, from a plan view along the Z-axis direction, is described as an example. In the description below, the four power transmission coils L1 are each given a number (n) to differentiate among the power transmission coils L1. The two power transmission coils L1 positioned on a movement path of the power reception coil L2 are given numbers (1) and (2) in order from upstream to downstream in a movement direction.

At step S1 in FIG. 6, a designer sets a value of each parameter. At step S3, mutual inductance M and self-inductance L at each position are acquired. As method for acquiring the inductances, a method using simulation and a method using actual measurement can be given. As a result of the setting of the position of the power reception coil L2 and the acquisition of the inductances being repeated, the inductances at position X that is a position in the X-axis direction can be acquired.

As shown at S3 in FIG. 7, for example, mutual inductance M21 that is the mutual inductance M between the power transmission coil L1 and the power reception coil L2 is maximum in the first position P1 in which the coil center axis CX of the power transmission coil L1 and the coil center axis CX of the power reception coil L2 coincide, from the plan view. Specifically, mutual inductance M21(1) that is the mutual inductance M between a power transmission coil L1(1) and the power reception coil L2 is maximum at a first position P1(1) in which the coil center axis CX of the power transmission coil L1(1) and the coil center axis CX of the power reception coil L2 coincide, from the plan view. In a similar manner, mutual inductance M21(2) that is the mutual inductance M between a power transmission coil L1(2) and the power reception coil L2 is maximum at a first position P1(2) in which the coil center axis CX of the power transmission coil L1(2) and the coil center axis CX of the power reception coil L2 coincide, from the plan view. Here, because a plurality of first positions P1 are present in correspondence to the arrangement mode in which the plurality of power transmission coils L1 are arranged, the first positions P1 are differentiated by denotations similar to that of the power transmission coils L1, that is, by the first position P1 being given a number (n).

Here, the self-inductance Lis omitted from S3 in FIG. 7. Moreover, in actuality, in addition to the mutual inductance M21(1) and the mutual inductance M21(2), mutual inductance M21(3) and mutual inductance M21(4) are acquired. However, to facilitate understanding, the description below is given under an assumption that the mutual inductance M21(3) and the mutual inductance M21(4) are small enough to be ignored compared to the mutual inductance M21(1) and the mutual inductance M21(2).

At step S5 in FIG. 6, the designer calculates the coupling coefficient k at each position. The coupling coefficient k is expressed by expression (b1), below, using the mutual inductance M, self-inductance L1 of the power transmission coil L1, and self-inductance L2 of the power reception coil L2.

$$M = k \sqrt{{L}_{1} {L}_{2}} \qquad ( b1 )$$

Specifically, a coupling coefficient k(1) that is the coupling coefficient between the power transmission coil L1(1) and the power reception coil L2, and a coupling coefficient k(2) that is the coupling coefficient between the power transmission coil L1(2) and the power reception coil L2 are calculated.

At step S7, the designer calculates the coupling coefficient sum kb at each position. The sum of the coupling coefficients k calculated for each position at step S5 is the coupling coefficient sum kb. In the example, the coupling coefficient sum kb is determined by the coupling coefficient k(1) and the coupling coefficient k(2) being added.

At step S9, the designer determines the maximum value between the coupling coefficient k and the coupling coefficient sum kb at each position. Specifically, at each position, the maximum value among the coupling coefficient k(1), the coupling coefficient k(2), and the coupling coefficient sum kb is determined. In the arrangement mode described as an example, as shown in FIG. 7, a characteristic line CL that is a curve drawn by the maximum values of the coupling coefficient k and the coupling coefficient sum kb at each position, has three local maximum points. According to the present embodiment, the power transmission coils L1 are all the same size and arranged in a matrix at equal intervals. Therefore, from a plan view, the characteristic line CL has a local maximum at a midway position between the coil center axis CX of the power transmission coil L1(1) and the coil center axis CX of the power transmission coil L1(2). That is, the midway position to the coil center axis CX of the power transmission coil L1(2) and the local maximum position P2(max) coincide.

That is, the characteristic line CL has local maximums in the first position P1(1), the first position P1(2), and the local maximum position P2(max). As described above, the first position P1(1) and the first position P1(2) are positions in which the coil center axis CX of the power transmission coil L1(1) and the coil center axis CX of the power transmission coil L1(2) coincide. The local maximum position P2(max) is the midway position between the coil center axis CX of the power transmission coil L1(1) and the coil center axis CX of the power transmission coil L1(2). When the power transmission coils L1 of the same size are arranged at equal intervals on the same plane, from a plan view, a center-of-gravity position of the coil center axis CX of each power transmission coil L1 of the power transmission coil group GL becomes the local maximum position P2(max).

The local maximum position P2(max) is a position of a local maximum point appearing on the characteristic line CL in a process of moving the power reception coil L2 from a position in which a coil center axis CX of a target power transmission coil coincides with the coil center axis CX of the power reception coil L2 to a position in which a coil center axis CX of the power transmission coil L1 adjacent to the target power transmission coil coincides with the coil center axis CX of the power reception coil L2, that is, in a section from the first position P1 to a next first position P1.

Here, the coupling coefficient k in the first position P1 is referred to as a first coupling coefficient ka. The coupling coefficient sum kb at the local maximum position P2(max) is referred to as the local maximum coupling coefficient sum kba.

At step S11 in FIG. 6, the designer determines whether a first difference D1 is less than a first target difference Dtg1. Here, the first difference D1 is expressed by expression (b2).

$$D 1 = \vert ka - kba \vert \qquad ( b2 )$$

The first target difference Dtg1 is set to a value that is at least equal to or less than half the maximum value Max(ka, kba) that is the greater value of the first coupling coefficient ka and the local maximum coupling coefficient sum kba. In the example, as shown at S11 in FIG. 7, the local maximum coupling coefficient sum kba is greater than the first coupling coefficient ka. Therefore, kba/2 is set as the first target difference Dtg1. Here, unlike that according to the present embodiment, the first target difference Dtg1 may be set to a value less than kba/2.

The power reception coil L2 receives power while changing the relative position to the power transmission coil L1. When the positional relationship between the power transmission coil L1 and the power reception coil L2 changes, the inductance changes. Therefore, power supply efficiency also changes. When a variation range of inductance due to displacement is reduced, a variation range of power supply efficiency decreases. This is preferable because power supply to the battery 84 can be stabilized. In other words, power supply to the battery 84 can be more stabilized as the first difference D1 decreases, and this is therefore preferable.

When determined that the first difference D1 is not less than the first target difference Dtglat step S11 in FIG. 6, at step S15, the designer changes the value of at least one parameter among the plurality of parameters set at step S1. After changing the parameter at step S15, the designer performs step S3 using the parameters after the change.

When determined that the first difference D1 is less than the first target difference Dtg1 at step S11 in FIG. 5, at step S13, the designer determines whether a second difference D2 is less than a second target difference Dtg2. Here, the second difference D2 is expressed by expression (b3).

$$D 2 = \vert kb - kbt \vert \qquad ( b3 )$$

As described above, kb in expression (b3) is the sum of the coupling coefficients k between the power transmission coils L1 of the power transmission coil group GL and the power reception coil L2. kbt in expression (b3) is the specific coupling coefficient sum kbt and is the coupling coefficient sum kb at the specific second position P2(id) in which at least one coupling coefficient k and the coupling coefficient sum kb coincide. In the example, as shown at S13 in FIG. 7, the coupling coefficient sum kb is the sum of the coupling coefficient k(1) and the coupling coefficient k(2). Therefore, a position in which the coupling coefficient k(2) is zero is the specific second position P2(id).

The second target difference Dtg2 is set in a manner similar to the first target difference Dtg1. That is, the second target difference Dtg2 is set to a value that is at least equal to or less than half the maximum value Max(ka, kba) that is the greater value of the first coupling coefficient ka and the local maximum coupling coefficient sum kba. In the example, because the local maximum coupling coefficient sum kba is greater than the first coupling coefficient ka, a value equal to or less than kba/2 is set as the second target difference Dtg2. According to the present embodiment, the second target difference Dtg2 is set to the same value as the first target difference Dtg1. Unlike that according to the present embodiment, the second target difference Dtg2 may be set to a value less than kba/2. In addition, the second target difference Dtg2 may be set to a value differing from the first target difference Dtg1.

In a manner similar to the first difference D1, power supply to the battery 84 can be more stabilized as the second difference D2 decreases, and this is therefore preferable.

When determined that the second difference D2 is not less than the second target difference Dtg2 at step S13, the designer proceeds to step S15. In contrast, when determined that the second difference D2 is less than the second target difference Dtg2 at step S13, because the variation range of power supply efficiency due to the displacement of the power reception coil L2 can be equal to or less than the target value, the designer ends the design.

Here, the design method described above can be implemented using a computer. Specifically, regarding step S1, step S3, and step S15, values can be acquired by receiving values input by the designer, and the design method can be realized by a computer executing a program actualizing the design method.

### A6. Details of a Power Supply Sequence

As described with reference to FIG. 3, at step S3 in FIG. 3, the switching circuit 44 sets the power transmission resonant circuit 42 to the resonant state and starts power supply. Then, at step S7 in FIG. 3, the switching circuit 44 sets the power transmission resonant circuit 42 to the non-resonant state and stops power supply. In addition, as described with reference to FIG. 4, the power transmission coils L1 that are in an array are switched in order from the standby state to the power supply state in correspondence to the movement of the power reception coil L2.

When determined that the power reception coil L2 is positioned at the specific second position P2(id), the switching circuit 44 switches the power transmission resonant circuit 42 between the non-power supply state and the power supply state. When described with reference to FIG. 5, at time t4 when the power reception coil L2 is positioned at the specific second position P2(id), the switching circuit 44 of the power transmission coil L1(2) switches the power transmission resonant circuit 42 from the non-power supply state to the power supply state. As a result, the wireless power supply apparatus 10 can efficiently perform power supply. Even should the power transmission resonant circuit 42 be switched to the power supply state from a time before time t4, effective power supply cannot be performed because the mutual inductance M is small. Therefore, as a result of the power transmission resonant circuit 42 being switched from the non-power supply state to the power supply state when the power reception coil L2 is determined to be positioned at the specific second position P2(id), power supply can be efficiently performed.

In a similar manner, at time t6 when the power reception coil L2 is positioned at the specific second position P2(id), the switching circuit 44 of the power transmission coil L1(1) switches the power transmission resonant circuit 42 from the power supply state to the non-power supply state.

### A7. Other Examples of the Arrangement Mode of the Power Transmission Coil and the Power Reception Coil

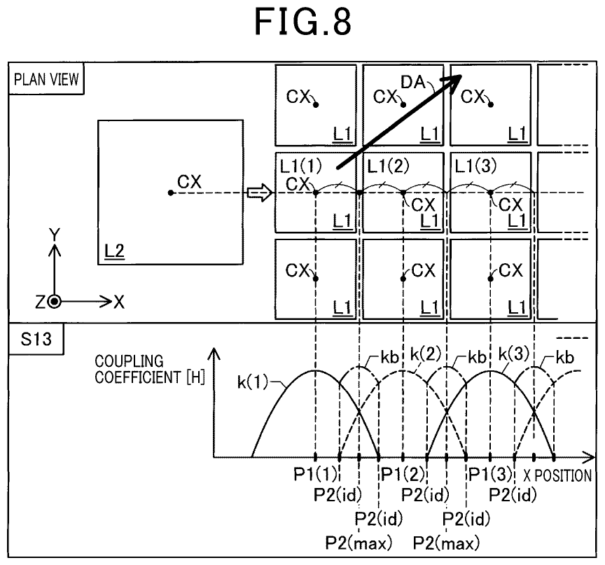

The description above is given using the case in which four power transmission coils L1 are arranged, with reference to FIG. 7. A number of power transmission coils L1 is not limited to four. For example, as shown in FIG. 8, the specific second position P2(id) can be determined in a manner similar to that described above even should three or more power transmission coils L1 be arrayed in the X-axis direction.

When the wireless power supply system 1 satisfies expression (1) and expression (6), above, the variation range of the variation in power supply efficiency accompanying movement of the power reception coil L2 can be suppressed, regardless of the movement path of the power reception coil L2. That is, the variation range of the variation in power supply efficiency accompanying movement of the power reception coil L2 can be suppressed, not only in cases in which the power reception coil L2 moves along the straight line connecting the coil center axes CX of the power transmission coils L1 as described above, but also in cases in which the power reception coil L2 moves in a direction intersecting the X-axis direction that is the array direction of the power transmission coils L1. In other words, the wireless power supply system 1 in which variation in the current supplied to the battery 84 is suppressed regardless of the movement path of the power reception coil L2 can be provided by expression (1) and expression (6) being satisfied.

According to the first embodiment described above, the plurality of power transmission coils L1 are arranged in a planar shape. Therefore, the power reception coil L2 can receive power from the plurality of power transmission coils L1 without the physical size in the height direction of the coil group GLA being increased. In addition, the first difference D1 between the first coupling coefficient ka and the local maximum coupling coefficient sum kba, and the maximum value Max(ka, kba) between the first coupling coefficient ka and the local maximum coupling coefficient sum kba satisfy expression (1). Therefore, when the power reception coil L2 receives power while changing the relative position to the power transmission coil L1, the variation range of power supply efficiency accompanying the movement can be reduced.

Furthermore, the power transmission resonant circuit 42 and the power reception resonant circuit 81 are configured such that the coupling coefficient k between the power transmission coil L1 and the power reception coil L2 and the power output to the battery 84 have a positive correlation. As a result, the power supplied to the battery 84 can be increased as the coupling coefficient k increases. Moreover, the wireless power supply system 1 is a so-called P-S wireless power supply system in which the power transmission resonant circuit 42 is a parallel resonant circuit and the power reception resonant circuit 81 is a series resonant circuit. As a result, a configuration in which the coupling coefficient k and the power output to the battery 84 have a positive correlation can be implemented.

In addition, the maximum outer diameter Dsmax of the power transmission coil L1, the minimum outer diameter Dsmin of the power transmission coil L1, the maximum outer diameter Drmax of the power reception coil L2, and the minimum outer diameter Drmin of the power reception coil L2 are such that the maximum outer diameter Dsmax and the minimum outer diameter Dsmin are the same and the maximum outer diameter Drmax and the minimum outer diameter Drmin are the same. Therefore, both expression (2) and expression (3), below, are satisfied.

$$Drmax > Dsmax \qquad ( 2 )$$

$$Drmin > Dsmin \qquad ( 3 )$$

As a result, in the second position P2, the power reception coil L2 can easily receive power from the plurality of power transmission coils L1. Therefore, the wireless power supply system 1 satisfying expression (1) and expression (6), above, can be implemented. Here, the maximum outer diameter Drmax is preferably about twice the maximum outer diameter Dsmax, and the minimum outer diameter Drmin about twice the minimum outer diameter Dsmin.

Furthermore, the second difference D2 between the first coupling coefficient ka and the specific coupling coefficient sum kbt, and the maximum value Max(ka, kba) between the first coupling coefficient ka and the local maximum coupling coefficient sum kba that is the local maximum value of the coupling coefficient sum kb, satisfy expression (6). Therefore, when the power reception coil L2 receives power while changing the relative position to the power transmission coil L1, the variation range of power supply efficiency accompanying the movement can be reduced.

### B. Second Embodiment

A power transmission resonant circuit 242 provided in a power transmission unit 240 according to a present embodiment has a circuit configuration differing from that of the power transmission resonant circuit 42 according to the above-described first embodiment. Configurations identical to those according to the above-described embodiment are given the same reference numbers. Detailed descriptions are omitted as appropriate.

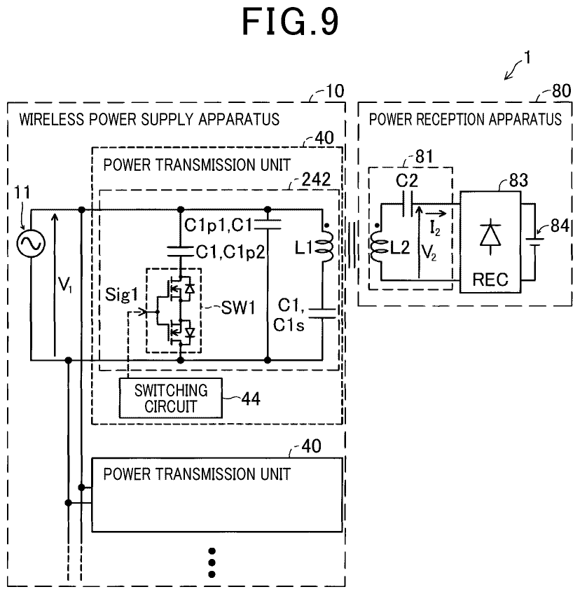

As shown in FIG. 9, the power transmission capacitor C1 of the power transmission resonant circuit 242 includes a first parallel primary capacitor C1p1 and a second parallel primary capacitor C1p2 serving as parallel primary capacitors, and a series primary capacitor C1s. The first switch SW1 is connected in series to the second parallel primary capacitor C1p2. A connection body of the second parallel primary capacitor C1p2 and the first switch SW1 is connected in parallel to the power transmission coil L1. The second parallel primary capacitor C1p2 is connected in parallel to the power transmission coil L1. The series primary capacitor C1s is connected in series to the power transmission coil L1. Respective capacitance values of the first parallel primary capacitor C1p1, the second parallel primary capacitor C1p2, and the series primary capacitor C1s are set to values resulting in the resonant state at the operating frequency when the first switch SW1 is set to the on state. The power transmission resonant circuit 242 and the power reception resonant circuit 81 perform so-called PS-S wireless power supply.

In the power transmission resonant circuit 242 as well, in a manner similar to the PS type, the coupling coefficient k between the power transmission coil L1 and the power reception coil L2, and the secondary voltage V2 have a positive correlation. Therefore, the coupling coefficient k and the power output to the battery 84 have a positive correlation.

According to the second embodiment described above, effects similar to those according to the above-described embodiment are obtained.

### C. Third Embodiment

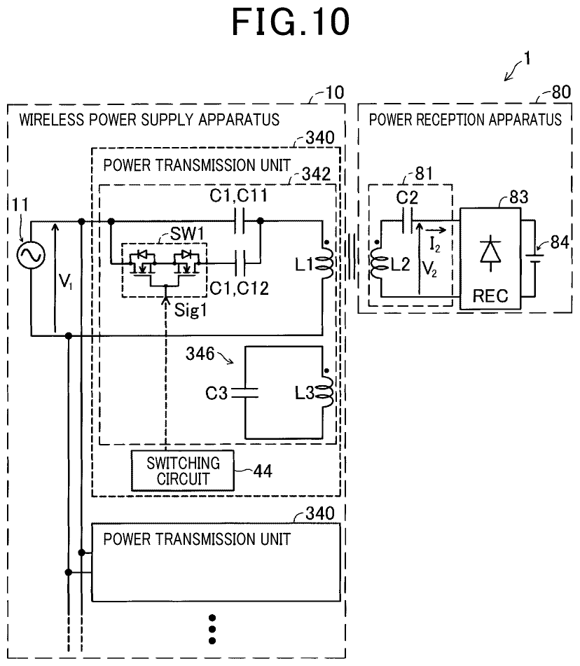

A power transmission unit 340 according to a present embodiment shown in FIG. 10 differs from those according to the above-described embodiments in that a coupling circuit 346 is included and in terms of a circuit configuration of the power transmission resonant circuit 342. Configurations identical to those according to the above-described embodiments are given the same reference numbers. Detailed descriptions are omitted as appropriate.

The power transmission unit 340 has the coupling circuit 346. The coupling circuit 346 is used to establish or interrupt a power transmission path between the power transmission unit 340 and the power reception apparatus 80. The coupling circuit 346 has a tertiary coil L3 and a tertiary capacitor C3. The tertiary capacitor C3 is connected in parallel to the tertiary coil L3. The tertiary coil L3 is disposed in a position enabling magnetic coupling with the power transmission coil L1. As a result, when the power transmission coil L1 and the power reception coil L2 are magnetically coupled, the power transmission coil L1, the power reception coil L2, and the tertiary coil L3 are magnetically coupled with one another.

The first power transmission capacitor C11 is connected in series to the power transmission coil L1. The second power transmission capacitor C12 is connected in series to the first switch SW1. A connection body of the second power transmission capacitor C12 and the first switch SW1 is connected in parallel to the first power transmission capacitor C11. The first switch SW1 is set to the on state when the power transmission resonant circuit 342 is set to the resonant state. A combined capacitance of the first power transmission capacitor C11 and the second power transmission capacitor C12 is set to a value in which the power transmission resonant circuit 342 enters the resonant state at the operating frequency.

A capacitance value of the tertiary capacitor C3 is set to a value in which a parallel resonant circuit formed by the tertiary coil L3 and the tertiary capacitor C3 enters the resonant state when the power transmission coil L1, the power reception coil L2, and the tertiary coil L3 are magnetically coupled with one another.

The switching circuit 44 switches the power transmission resonant circuit 342 from the non-resonant state to the resonant state, and switches the power transmission unit 340 from the standby state to the power supply state. Specifically, the switching circuit 44 switches the first switch SW1 from the off state to the on state, as described above. As a result, the power supply current flows through the power transmission coil L1 and the tertiary coil L3 magnetically coupled with the power transmission coil L1, and power is supplied to the power reception coil L2 without contact.

In contrast, the switching circuit 44 switches the power transmission resonant circuit 342 from the resonant state to the non-resonant state, and switches the power transmission unit 340 from the power supply state to the standby state. Specifically, the switching circuit 44 switches the first switch SW1 from the on state to the off state, as described above. As a result, the power transmission unit 340 is switched to the standby state in which the standby current that is smaller than the power supply current flows to the power transmission coil L1.

Most of the power received by the power reception resonant circuit 81 from the power transmission unit 340 is due to magnetic coupling between the power reception coil L2 and the tertiary coil L3. Therefore, a current value of a current I2 flowing to the power reception coil L2 increases as the coupling coefficient k between the tertiary coil L3 and the power reception coil L2 increases. According to the first embodiment, the sizes of the power transmission coil L1 and the power reception coil L2, the spacing between the power transmission coils L1, and the distance in the height direction between the power transmission coil L1 and the power reception coil L2 are each set to satisfy expression (1) and expression (6), above. In contrast, according to the present embodiment, the sizes of the tertiary coil L3 and the power reception coil L2, the spacing between the tertiary coils L3, and the distance in the height direction between the tertiary coil L3 and the power reception coil L2 are each set to satisfy expression (1) and expression (6), above. That is, according to the present embodiment, the tertiary coil L3 is arranged in a manner similar to the power transmission coil L1 shown in FIG. 8.

According to the present embodiment, the capacitance value of the power transmission capacitor C1 is C1, the self-inductance of the power transmission coil L1 is L1, the capacitance value of the power reception capacitor C2 is C2, the self-inductance of the power reception coil L2 is L2, the capacitance value of the tertiary capacitor C3 is C3, the self-inductance of the tertiary coil L3 is L3, the coupling coefficient between the power transmission coil L1 and the power reception coil L2 is k12, the coupling coefficient between the power transmission coil L1 and the tertiary coil L3 is k13, the coupling coefficient between the power reception coil L2 and the tertiary coil L3 is k32, and the angular frequency of the alternating-current power output from the alternating-current power source 11 is ω. The capacitance value C1 is set to satisfy expression (c1), the capacitance value C2 is set to satisfy expression (c2), and the capacitance value C3 is set to satisfy expression (c3). In this case, the secondary voltage V2 is ideally expressed by expression (c4).

$$C 1 = 1 / ( ω 2 \cdot L 1 ) \qquad ( c1 )$$

$$C 2 = 1 / ( ω 2 \cdot L 2 ( 1 - ( 2 \cdot k 32 k 12 ) / k 13 ) ) \qquad ( c2 )$$

$$C 3 = 1 / ( ω 2 \cdot L 3 ) \qquad ( c3 )$$

$${V}_{2} = \frac{{k}_{32}}{{k}_{13}} \frac{1}{\sqrt{\frac{{L}_{1}}{{L}_{2}}}} {V}_{1} \qquad ( c4 )$$

Therefore, in the power transmission resonant circuit 342 as well, k32 that is the coupling coefficient k between the tertiary coil L3 and the power reception coil L2, and the secondary voltage V2 have a positive correlation. Therefore, the coupling coefficient k32 between the tertiary coil L3 and the power reception coil L2 and the power output from the power reception resonant circuit 81 to the battery 84 have a positive correlation.

According to the third embodiment described above, effects similar to those according to the above-described embodiments are obtained.

### D. Fourth Embodiment

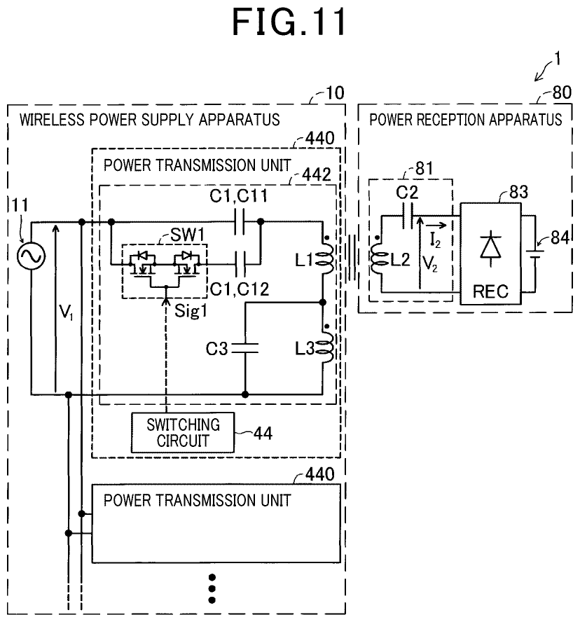

A power transmission unit 440 according to a present embodiment shown in FIG. 11 differs from that according to the third embodiment in terms of circuit configuration. Configurations identical to those according to the above-described embodiments are given the same reference numbers. Detailed descriptions are omitted as appropriate.

According to the present embodiment, the circuit configuration is such that the coupling circuit 346 according to the third embodiment is connected to a power transmission resonant circuit 442. Specifically, the tertiary coil L3 is connected in series to the power transmission coil L1. The tertiary capacitor C3 is connected in parallel to the tertiary coil L3.

According to the present embodiment as well, in a manner similar to that according to the third embodiment, the capacitance value of the tertiary capacitor C3 is set to a value in which the parallel resonant circuit formed by the tertiary coil L3 and the tertiary capacitor C3 enters the resonant state when the power transmission coil L1, the power reception coil L2, and the tertiary coil L3 are magnetically coupled with one another. Most of the power received by the power reception resonant circuit 81 from the power transmission unit 440 is due to magnetic coupling between the power reception coil L2 and the tertiary coil L3. Therefore, the current value of the current I2 flowing to the power reception coil L2 increases as the coupling coefficient k between the tertiary coil L3 and the power reception coil L2 increases. In addition, the sizes of the tertiary coil L3 and the power reception coil L2, the spacing between the tertiary coils L3, and the distance in the height direction between the tertiary coil L3 and the power reception coil L2 are each set to satisfy expression (1) and expression (6), above.

In the power transmission resonant circuit 442 as well, the coupling coefficient k between the power transmission coil L1 and the power reception coil L2, and the secondary voltage V2 have a positive correlation.

According to the fourth embodiment described above, effects similar to those according to the above-described embodiments are obtained.

### E. Fifth Embodiment

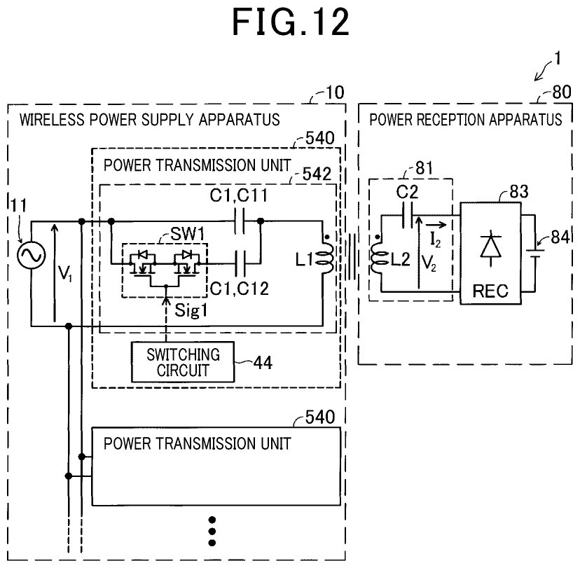

A power transmission unit 440 according to a present embodiment shown in FIG. 12 differs from those according to the above-described embodiments in terms of the circuit configuration of a power transmission resonant circuit 542. Configurations identical to those according to the above-described embodiments are given the same reference numbers. Detailed descriptions are omitted as appropriate.

The first power transmission capacitor C11 is connected in series to the power transmission coil L1. The second power transmission capacitor C12 is connected in series to the first switch SW1. A connection body of the second power transmission capacitor C12 and the first switch SW1 is connected in parallel to the first power transmission capacitor C11. The first switch SW1 is set to the on state when the power transmission resonant circuit 542 is set to the resonant state. A combined capacitance of the first power transmission capacitor C11 and the second power transmission capacitor C12 is set to a value in which the power transmission resonant circuit 542 enters the resonant state at the operating frequency. The power transmission resonant circuit 542 and the power reception resonant circuit 81 perform so-called S-S wireless power supply.

In addition, when the self-inductance of the power transmission coil L1 is L1, the capacitance value of the power transmission capacitor C1, that is, the combined capacitance of the first power transmission capacitor C11 and the second power transmission capacitor C12 is C1, the self-inductance of the power reception coil L2 is L2, the capacitance value of the power reception capacitor C2 is C2, the coupling coefficient between the power transmission coil L1 and the power reception coil L2 is k, and the angular frequency of the AC power of the AC power source 11 is ω, the capacitance value C1 satisfies expression (4), below, and the capacitance value C2 satisfies expression (5), below.

$$C 1 = 1 / ( ω 2 \times L 1 \times ( 1 + k ) ) \qquad ( 4 )$$

$$C 2 = 1 / ( ω 2 \times L 2 \times ( 1 + k ) ) \qquad ( 5 )$$

Therefore, the coupling coefficient k between the power transmission coil L1 and the power reception coil L2, and the power output from the power reception resonant circuit 81 to the battery 84 have a positive correlation.

According to the fifth embodiment described above, effects similar to those according to the above-described embodiments are obtained.

### F. Sixth Embodiment

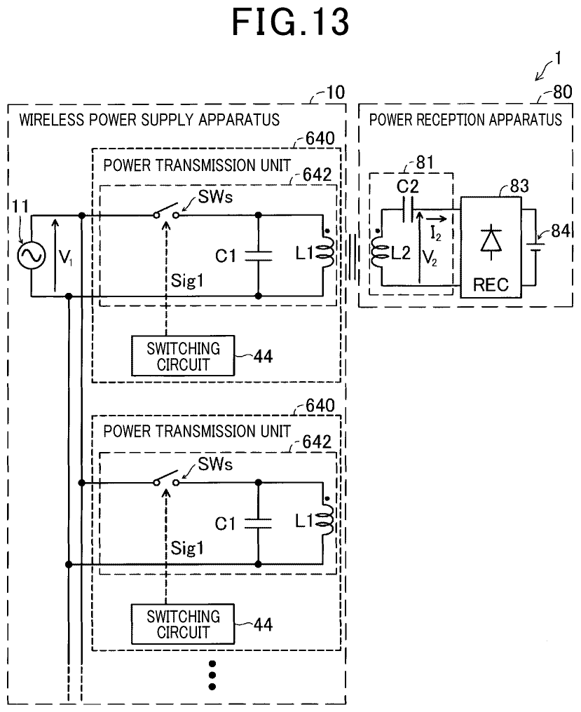

A power transmitting unit 640 according to a present embodiment shown in FIG. 13 differs from those according to the above-described embodiments in terms of the circuit configuration of a power transmission resonant circuit 642. Configurations identical to those according to the above-described embodiments are given the same reference numbers. Detailed descriptions are omitted as appropriate.

The power transmission resonant circuit 642 has a changeover switch SWs that switches between whether alternating-current power supplied from the alternating-current power supply 11 is supplied to the power transmission coil L1. For example, the changeover switch SWs may be implemented by a semiconductor switch. The switching circuit 44 controls the changeover switch SWs. The power transmission capacitor C1 is connected in parallel to the power transmission coil L1.

At the specific second position P2(id) (S13 in FIG. 7), the switching circuit 44 switches a state of the changeover switch SWs between an on state that is a supply state in which the alternating-current power is supplied to the power transmission coil L1 and an off state that is a stop state in which the alternating-current power is not supplied to the power transmission coil L1. That is, the switching circuit 44 sets the changeover switch SWs to the on state and sets the power transmission resonant circuit 642 to the power supply state. The switching circuit 44 sets the changeover switch SWs to the off state and sets the power transmission resonant circuit 642 to the non-power supply state. As a result, power supply can be efficiently performed.

According to the sixth embodiment described above, effects similar to those according to the above-described embodiments are obtained.

### G. Other Embodiments

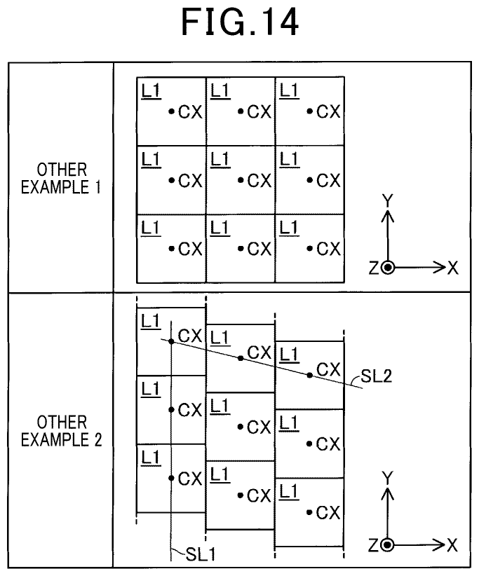

(G1) According to the first embodiment, described above, the shapes of the power transmission coil L1 and the power reception coil L2 projected onto the coil plane Sc are substantially square. The power transmission coil L1 and the power reception coil L2 may have other shapes. Specifically, the shape projected onto the coil plane Sc may be a circle, a rectangle, or other polygons. In addition, according to the first embodiment, the power transmission coils L1 are arranged at equal intervals with the coil spacing Gs therebetween. The arrangement mode of the plurality of power transmission coils L1 is not limited thereto. For example, as shown in other example 1 in FIG. 14, the plurality of power transmission coils L1 may be arranged without the coil spacing Gs therebetween. Furthermore, as shown in other example 2, the plurality of power transmission coils L1 may be arranged such that a straight line SL1 connecting the coil center axes CX of the plurality of power transmission coils L1 arrayed in the Y-axis direction and a straight line SL2 connecting the coil center axes CX of the plurality of power transmission coils L1 arrayed in the X-axis direction are not perpendicular to each other. Moreover, the plurality of power transmission coils L1 may be arranged in an irregular manner. This similarly applies to the tertiary coil L3 according to the third and fourth embodiments.

(G2) According to the first embodiment, described above, the switching element configuring the first switch SW1 is implemented by an FET. According to another embodiment, the switching element may be implemented by another semiconductor element, such as an insulated gate bipolar transistor (IGBT) to which a freewheeling diode is connected. In addition, the first switch SW1 is not limited to a bidirectional switch, and may be a unidirectional switch configured by a single switching element.

The present disclosure is not limited to the above-described embodiments and variation examples, and can be implemented by various configurations without departing from the spirit of the disclosure. For example, technical features according to embodiments and modifications that correspond to technical features in each aspect described in the summary of the invention can be replaced and combined as appropriate to solve some or all of the above-described issued or to achieve some or all of the above-described effects.

Furthermore, the technical features may be omitted as appropriate unless described as a requisite in the present specification.

### H. Other Aspects

Characteristics of the present disclosure are as follows:

### [Aspect 1]

A coil group (GLA) including: a plurality of primary coils (L1); and a secondary coil (L2) of which a relative position to the plurality of primary coils is able to be changed, in which: the plurality of primary coils are arranged in a planar shape, the secondary coil is capable of receiving power without contact from at least one of the plurality of primary coils while changing the relative position, the secondary coil is able to be displaced between a first position (P1) in which a center axis (CX) of the secondary coil coincides with a center axis (CX) of one target primary coil among the plurality of primary coils and a second position (P2) in which the center axis of the secondary coil does not coincide with the center axis of any of the plurality of primary coils, and power is able to be received from a primary coil group (GL) including at least two of the plurality of primary coils; and when a first coupling coefficient is ka, the first coupling coefficient ka being a coupling coefficient between the target primary coil and the secondary coil in the first position is ka, and a local maximum coupling coefficient sum is kba, the local maximum coupling coefficient sum being a coupling coefficient sum at a local maximum position (P2(max)) in the second position in which the coupling coefficient sum is a local maximum, the coupling coefficient sum being a sum of the coupling coefficients between the primary coils of the first primary coil group and the secondary coil,
the first coupling coefficient ka and the local maximum coupling coefficient sum kba satisfy expression (1), below,

$$D 1 < 1 / 2 \times Max ( ka , kba ) \qquad ( 1 )$$

where D1 is a first difference between the first coupling coefficient ka and the local maximum coupling coefficient sum kba, and Max(ka, kba) is a maximum value between the first coupling coefficient ka and the local maximum coupling coefficient sum kba.

### [Aspect 2]

A wireless power supply system (1) including the coil group according to the aspect 1, the wireless power supply system including: a plurality of power transmission resonant circuits (42, 242 to 642) corresponding to the plurality of primary coils; a power reception resonant circuit (81) having the secondary coil and a secondary capacitor (C2); and a power storage apparatus (84) that stores power received by the secondary coil, in which each of the plurality of power transmission resonant circuits includes a corresponding primary coil of the plurality of primary coils and a primary capacitor (C1), and each of the plurality of power transmission resonant circuits and the power reception resonant circuit are configured such that a coupling coefficient between the primary coil and the secondary coil, and power output to the power storage apparatus have a positive correlation.

### [Aspect 3]

The coil group according to the aspect 1 or 2, in which: when a maximum outer diameter of the primary coil is Dsmax, a minimum outer diameter of the primary coil is Dsmin, a maximum outer diameter of the secondary coil is Drmax, and a minimum outer diameter of the secondary coil is Drmin,
at least either of expression (2) and expression (3), below, is satisfied.

$$Drmax > Dsmax \qquad ( 2 )$$

$$Drmin > Dsmin \qquad ( 3 )$$

### [Aspect 4]

The wireless power supply system according to the aspect 2 or 3, in which: each of the plurality of power transmission resonant circuits is a parallel resonant circuit in which the primary capacitor is connected in parallel to the primary coil; and the power reception resonant circuit is a series resonant circuit in which the secondary capacitor is connected in series to the secondary coil.

### [Aspect 5]

The wireless power supply system according to the aspect 2 or 3, in which: the primary capacitor includes a parallel primary capacitor (C1p1, C1p2) connected in parallel to the primary coil and a series primary capacitor (C1s) connected in series to the primary coil; each of the plurality of power transmission resonant circuit is a resonant circuit configured by the primary coil, the parallel primary capacitor, and the series primary capacitor; and the power reception resonant circuit is a series resonant circuit in which the secondary capacitor is connected in series to the secondary coil.

### [Aspect 6]

A wireless power supply system (1) including the coil group according to the aspect 1, the wireless power supply system including: a plurality of power transmission resonant circuits (342) corresponding to the plurality of primary coils; a power reception resonant circuit (81) having the secondary coil and a secondary capacitor (C2); and a power storage apparatus (84) that stores power received by the secondary coil, in which each of the plurality of power transmission resonant circuits includes (i) a series resonant circuit having a corresponding primary coil of the plurality of primary coils and a capacitor (C1) connected in series to the primary coil, and (ii) a coupling circuit (346) having a tertiary coil (L3) that is able to be magnetically coupled with the primary coil and a tertiary capacitor (C3) connected in parallel to the tertiary coil, the power reception resonant circuit is a series resonant circuit in which the secondary capacitor is connected in series to the secondary coil, and each of the plurality of power transmission resonant circuits and the power reception resonant circuit are configured such that a coupling coefficient between the tertiary coil and the secondary coil, and power output to the power storage apparatus have a positive correlation.

### [Aspect 7]

A wireless power supply system (1) including the coil group according to the aspect 1, the wireless power supply system including: a plurality of power transmission resonant circuits (442) corresponding to the plurality of primary coils; a power reception resonant circuit (81) having the secondary coil and a secondary capacitor (C2); and a power storage apparatus (84) that stores power received by the secondary coil, in which each of the plurality of power transmission resonant circuits includes a corresponding primary coil of the plurality of primary coils, a primary capacitor (C1) connected in series to the primary coil, a tertiary coil (L3) that is able to be magnetically connected with the primary coil and connected in series to the primary coil, and a tertiary capacitor (C3) connected in parallel to the tertiary coil, and the power reception resonant circuit is a series resonant circuit in which the secondary capacitor is connected in series to the secondary coil, and each of the plurality of power transmission resonant circuits and the power reception resonant circuit are configured such that a coupling coefficient between the tertiary coil and the secondary coil, and power output to the power storage apparatus have a positive correlation.

### [Aspect 8]

The wireless power supply system according to the aspect 2 or 3, further including: an alternating-current power supply (11) that supplies alternating-current power at an operating frequency prescribed in advance to the plurality of power transmission resonant circuits, in which each of the plurality of power transmission resonant circuits is a series resonant circuit in which the primary capacitor is connected in series to the primary coil, the power reception resonant circuit is a series resonant circuit in which the secondary capacitor is connected in series to the secondary coil, and when self-inductance of the primary coil is L1, a capacitance value of the primary capacitor is C1, self-inductance of the secondary coil is L2, a capacitance value of the secondary capacitor is C2, a coupling coefficient between the primary coil and the secondary coil is k, and an angular frequency of the alternating-current power is ω,
the capacitance value C1 satisfies expression (4), below, and the capacitance value C2 satisfies expression (5), below.

$$C 1 = 1 / ( ω 2 \times L 1 \times ( 1 + k ) ) \qquad ( 4 )$$

$$C 2 = 1 / ( ω 2 \times L 2 \times ( 1 + k ) ) \qquad ( 5 )$$

### [Aspect 9]

A coil group (GLA) including: a plurality of primary coils (L1); and a secondary coil (L2) of which a relative position to the plurality of primary coils is able to be changed, in which the plurality of primary coils are arranged in a planar shape, the secondary coil is capable of receiving power without contact from at least one of the plurality of primary coils while changing the relative position, the secondary coil is able to be displaced between a first position (P1) in which a center axis (CX) of the secondary coil coincides with a center axis (CX) of one target primary coil among the plurality of primary coils and a second position (P2) in which the center axis of the secondary coil does not coincide with the center axis of any of the plurality of primary coils, and power is able to be received from a primary coil group (GL) including at least two of the plurality of primary coils; and when a first coupling coefficient is ka, the first coupling coefficient ka being a coupling coefficient between the target primary coil and the secondary coil in the first position, a specific coupling coefficient sum is kbt, the specific coupling coefficient sum kbt being a coupling coefficient sum at a specific second position (P2(id)) in the second position in which (i) at least any one of the coupling coefficients between the primary coils in the primary coil group and the secondary coil in the second position that are the plurality of coupling coefficients corresponding to the plurality of primary coils included in the primary coil group and (ii) a coupling coefficient sum that is a sum of the coupling coefficients of the primary coils in the primary coil group and the secondary coil coincide,
the first coupling coefficient ka and the specific coupling coefficient sum kbt satisfy expression (6), below,

$$D 2 < 1 / 2 \times Max ( ka , kba ) \qquad ( 6 )$$

where D2 is a difference between the first coupling coefficient ka and the specific coupling coefficient sum kbt, and Max(ka, kba) is a maximum value between the first coupling coefficient ka and a local maximum coupling coefficient sum kba that is a local maximum of the coupling coefficient sum.

### [Aspect 10]

A wireless power supply system (1) including the coil group according to the aspect 9, the wireless power supply system including: a plurality of power transmission resonant circuits (42, 242 to 642) corresponding to the plurality of primary coils; a power reception resonant circuit (81) having the secondary coil and a secondary capacitor (C2); and a power storage apparatus (84) that stores power received by the secondary coil, in which each of the plurality of power transmission resonant circuits includes a corresponding primary coil of the plurality of primary coils and a primary capacitor (C1), and each of the plurality of power transmission resonant circuits and the power reception resonant circuit are configured such that a coupling coefficient between the primary coil and the secondary coil, and power output to the power storage apparatus have a positive correlation.

### [Aspect 11]

The coil group according to the aspect 9 or 10, in which: when a maximum outer diameter of the primary coil is Dsmax, a minimum outer diameter of the primary coil is Dsmin, a maximum outer diameter of the secondary coil is Drmax, and a minimum outer diameter of the secondary coil is Drmin,
at least either of expression (2) and expression (3), below, is satisfied.

$$Drmax > Dsmax \qquad ( 2 )$$

$$Drmin > Dsmin \qquad ( 3 )$$

### [Aspect 12]

12. The wireless power supply system according to any one of the aspects 9 to 11, further including: a switching circuit that switches a state of the power transmission resonant circuit at the specific second position between a power supply state in which power is supplied from the primary coil to the secondary coil and a non-power supply state in which power is not supplied from the primary coil to the secondary coil.

### [Aspect 13]

The wireless power supply system according to any one of the aspects 10 to 12, in which: each of the plurality of power transmission resonant circuits is a parallel resonant circuit in which the primary capacitor is connected in parallel to the primary coil; and the power reception resonant circuit is a series resonant circuit in which the secondary capacitor is connected in series to the secondary coil.

### [Aspect 14]

The wireless power supply system according to any one of the aspects 10 to 12, in which: the primary capacitor includes a parallel primary capacitor (C1p1, C1p2) connected in parallel to the primary coil and a series primary capacitor (Cs) connected in series to the primary coil; each of the plurality of power transmission resonant circuit is a resonant circuit configured by the primary coil, the parallel primary capacitor, and the series primary capacitor; and the power reception resonant circuit is a series resonant circuit in which the secondary capacitor is connected in series to the secondary coil.

### [Aspect 15]

A wireless power supply system (1) including the coil group according to the aspect 9, the wireless power supply system including: a plurality of power transmission resonant circuits (342) corresponding to the plurality of primary coils; a power reception resonant circuit (81) having the secondary coil and a secondary capacitor (C2); and a power storage apparatus (84) that stores power received by the secondary coil, in which each of the plurality of power transmission resonant circuits includes (i) a series resonant circuit having a corresponding primary coil of the plurality of primary coils and a capacitor (C1) connected in series to the primary coil, and (ii) a coupling circuit (346) having a tertiary coil (L3) that is able to be magnetically coupled with the primary coil and a tertiary capacitor (C3) connected in parallel to the tertiary coil, and the power reception resonant circuit is a series resonant circuit in which the secondary capacitor is connected in series to the secondary coil, and each of the plurality of power transmission resonant circuits and the power reception resonant circuit are configured such that a coupling coefficient between the tertiary coil and the secondary coil, and power output to the power storage apparatus have a positive correlation.

### [Aspect 16]

A wireless power supply system (1) including the coil group according to the aspect 9, the wireless power supply system including: a plurality of power transmission resonant circuits (442) corresponding to the plurality of primary coils; a power reception resonant circuit (81) having the secondary coil and a secondary capacitor (C2); and a power storage apparatus (84) that stores power received by the secondary coil, in which each of the plurality of power transmission resonant circuits includes a corresponding primary coil of the plurality of primary coils, a primary capacitor (C1) connected in series to the primary coil, a tertiary coil (L3) that is able to be magnetically connected with the primary coil and connected in series to the primary coil, and a tertiary capacitor (C3) connected in parallel to the tertiary coil, the power reception resonant circuit is a series resonant circuit in which the secondary capacitor is connected in series to the secondary coil, and each of the plurality of power transmission resonant circuits and the power reception resonant circuit are configured such that a coupling coefficient between the tertiary coil and the secondary coil, and power output to the power storage apparatus have a positive correlation.

### [Aspect 17]

The wireless power supply system according to any one of the aspects 10 to 12, further including: an alternating-current power supply (11) that supplies alternating-current power at an operating frequency prescribed in advance to the plurality of power transmission resonant circuits, in which each of the plurality of power transmission resonant circuits is a series resonant circuit in which the primary capacitor is connected in series to the primary coil, the power reception resonant circuit is a series resonant circuit in which the secondary capacitor is connected in series to the secondary coil, and when self-inductance of the primary coil is L1, a capacitance value of the primary capacitor is C1, self-inductance of the secondary coil is L2, a capacitance value of the secondary capacitor is C2, a coupling coefficient between the primary coil and the secondary coil is k, and an angular frequency of the alternating-current power is ω, the capacitance value C1 satisfies expression (4), below, and the capacitance value C2 satisfies expression (5), below.

$$C 1 = 1 / ( ω 2 \times L 1 \times ( 1 + k ) ) \qquad ( 4 )$$

$$C 2 = 1 / ( ω 2 \times L 2 \times ( 1 + k ) ) \qquad ( 5 )$$

What is claimed is:

1. A coil group comprising:
a plurality of primary coils; and
a secondary coil of which a relative position to the plurality of primary coils is able to be changed, wherein:
the plurality of primary coils are arranged in a planar shape,
the secondary coil is capable of receiving power without contact from at least one of the plurality of primary coils while changing the relative position,
the secondary coil is able to be displaced between
a first position in which a center axis of the secondary coil coincides with a center axis of one target primary coil among the plurality of primary coils and
a second position in which the center axis of the secondary coil does not coincide with the center axis of any of the plurality of primary coils, and power is able to be received from a primary coil group including at least two of the plurality of primary coils; and
when a first coupling coefficient is ka, the first coupling coefficient ka being a coupling coefficient between the target primary coil and the secondary coil in the first position, and a local maximum coupling coefficient sum is kba, the local maximum coupling coefficient sum being a coupling coefficient sum at a local maximum position in the second position in which the coupling coefficient sum is a local maximum, the coupling coefficient sum being a sum of the coupling coefficients between the primary coils of the first primary coil group and the secondary coil,
the first coupling coefficient ka and the local maximum coupling coefficient sum kba satisfy expression (1), below,
$$D 1 < 1 / 2 \times Max ( ka , kba ) \qquad ( 1 )$$
where D1 is a difference between the first coupling coefficient ka and the local maximum coupling coefficient sum kba, and Max(ka, kba) is a maximum value between the first coupling coefficient ka and the local maximum coupling coefficient sum kba.

2. A wireless power supply system including the coil group according to claim 1, the wireless power supply system comprising:
a plurality of power transmission resonant circuits corresponding to the plurality of primary coils;
a power reception resonant circuit having the secondary coil and a secondary capacitor; and
a power storage apparatus that stores power received by the secondary coil, wherein
each of the plurality of power transmission resonant circuits includes a corresponding primary coil of the plurality of primary coils and a primary capacitor, and
each of the plurality of power transmission resonant circuits and the power reception resonant circuit are configured such that a coupling coefficient between the primary coil and the secondary coil, and power output to the power storage apparatus have a positive correlation.

3. The coil group according to claim 1, wherein:
when a maximum outer diameter of the primary coil is Dsmax, a minimum outer diameter of the primary coil is Dsmin, a maximum outer diameter of the secondary coil is Drmax, and a minimum outer diameter of the secondary coil is Drmin,
at least either of expression (2) and expression (3), below, is satisfied.
$$Drmax > Dsmax \qquad ( 2 )$$
$$Drmin > Dsmin \qquad ( 3 )$$

4. The wireless power supply system according to claim 2, wherein:
each of the plurality of power transmission resonant circuits is a parallel resonant circuit in which the primary capacitor is connected in parallel to the primary coil; and
the power reception resonant circuit is a series resonant circuit in which the secondary capacitor is connected in series to the secondary coil.

5. The wireless power supply system according to claim 2, wherein:
the primary capacitor includes a parallel primary capacitor connected in parallel to the primary coil and a series primary capacitor connected in series to the primary coil;
each of the plurality of power transmission resonant circuit is a resonant circuit configured by the primary coil, the parallel primary capacitor, and the series primary capacitor; and
the power reception resonant circuit is a series resonant circuit in which the secondary capacitor is connected in series to the secondary coil.

6. A wireless power supply system including the coil group according to claim 1, the wireless power supply system comprising:
a plurality of power transmission resonant circuits corresponding to the plurality of primary coils;
a power reception resonant circuit having the secondary coil and a secondary capacitor; and
a power storage apparatus that stores power received by the secondary coil, wherein
each of the plurality of power transmission resonant circuits includes (i) a series resonant circuit having a corresponding primary coil of the plurality of primary coils and a capacitor connected in series to the primary coil, and (ii) a coupling circuit having a tertiary coil that is able to be magnetically coupled with the primary coil and a tertiary capacitor connected in parallel to the tertiary coil,
the power reception resonant circuit is a series resonant circuit in which the secondary capacitor is connected in series to the secondary coil, and
each of the plurality of power transmission resonant circuits and the power reception resonant circuit are configured such that a coupling coefficient between the tertiary coil and the secondary coil, and power output to the power storage apparatus have a positive correlation.

7. A wireless power supply system including the coil group according to claim 1, the wireless power supply system comprising:
a plurality of power transmission resonant circuits corresponding to the plurality of primary coils;
a power reception resonant circuit having the secondary coil and a secondary capacitor; and
a power storage apparatus that stores power received by the secondary coil, wherein
each of the plurality of power transmission resonant circuits includes a corresponding primary coil of the plurality of primary coils, a primary capacitor connected in series to the primary coil, a tertiary coil that is able to be magnetically connected with the primary coil and connected in series to the primary coil, and a tertiary capacitor connected in parallel to the tertiary coil, and the power reception resonant circuit is a series resonant circuit in which the secondary capacitor is connected in series to the secondary coil, and
each of the plurality of power transmission resonant circuits and the power reception resonant circuit are configured such that a coupling coefficient between the tertiary coil and the secondary coil, and power output to the power storage apparatus have a positive correlation.

8. The wireless power supply system according to claim 2, further comprising:
an alternating-current power supply that supplies alternating-current power at an operating frequency prescribed in advance to the plurality of power transmission resonant circuits, wherein
each of the plurality of power transmission resonant circuits is a series resonant circuit in which the primary capacitor is connected in series to the primary coil,
the power reception resonant circuit is a series resonant circuit in which the secondary capacitor is connected in series to the secondary coil, and
when self-inductance of the primary coil is L1, a capacitance value of the primary capacitor is C1, self-inductance of the secondary coil is L2, a capacitance value of the secondary capacitor is C2, a coupling coefficient between the primary coil and the secondary coil is k, and an angular frequency of the alternating-current power is ω,
the capacitance value C1 satisfies expression (4), below, and the capacitance value C2 satisfies expression (5), below.
$$C 1 = 1 / ( ω 2 \times L 1 \times ( 1 + k ) ) \qquad ( 4 )$$
$$C 2 = 1 / ( ω 2 \times L 2 \times ( 1 + k ) ) \qquad ( 5 )$$

9. A coil group comprising:
a plurality of primary coils; and
a secondary coil of which a relative position to the plurality of primary coils is able to be changed, wherein
the plurality of primary coils are arranged in a planar shape,
the secondary coil is capable of receiving power without contact from at least one of the plurality of primary coils while changing the relative position,
the secondary coil is able to be displaced between
a first position in which a center axis of the secondary coil coincides with a center axis of one target primary coil among the plurality of primary coils and
a second position in which the center axis of the secondary coil does not coincide with the center axis of any of the plurality of primary coils, and power is able to be received from a primary coil group including at least two of the plurality of primary coils; and
when a first coupling coefficient is ka, the first coupling coefficient ka being a coupling coefficient between the target primary coil and the secondary coil in the first position, a specific coupling coefficient sum is kbt, the specific coupling coefficient sum kbt being a coupling coefficient sum at a specific second position in the second position in which (i) at least any one of the coupling coefficients between the primary coils in the primary coil group and the secondary coil in the second position that are the plurality of coupling coefficients corresponding to the plurality of primary coils included in the primary coil group and (ii) a coupling coefficient sum that is a sum of the coupling coefficients of the primary coils in the primary coil group and the secondary coil coincide,
the first coupling coefficient ka and the specific coupling coefficient sum kbt satisfy expression (6), below,
$$D 2 < 1 / 2 \times Max ( ka , kba ) \qquad ( 6 )$$
where D2 is a difference between the first coupling coefficient ka and the specific coupling coefficient sum kbt, and Max(ka, kba) is a maximum value between the first coupling coefficient ka and a local maximum coupling coefficient sum kba that is a local maximum of the coupling coefficient sum.

10. A wireless power supply system including the coil group according to claim 9, the wireless power supply system comprising:
a plurality of power transmission resonant circuits corresponding to the plurality of primary coils;
a power reception resonant circuit having the secondary coil and a secondary capacitor; and
a power storage apparatus that stores power received by the secondary coil, wherein
each of the plurality of power transmission resonant circuits includes a corresponding primary coil of the plurality of primary coils and a primary capacitor, and each of the plurality of power transmission resonant circuits and the power reception resonant circuit are configured such that a coupling coefficient between the primary coil and the secondary coil, and power output to the power storage apparatus have a positive correlation.

11. The coil group according to claim 9, wherein:
when a maximum outer diameter of the primary coil is Dsmax, a minimum outer diameter of the primary coil is Dsmin, a maximum outer diameter of the secondary coil is Drmax, and a minimum outer diameter of the secondary coil is Drmin,
at least either of expression (2) and expression (3), below, is satisfied.
$$Drmax > Dsmax \qquad ( 2 )$$
$$Drmin > Dsmin \qquad ( 3 )$$

12. The wireless power supply system according to claim 10, further comprising:
a switching circuit that switches a state of the power transmission resonant circuit at the specific second position between a power supply state in which power is supplied from the primary coil to the secondary coil and a non-power supply state in which power is not supplied from the primary coil to the secondary coil.

13. The wireless power supply system according to claim 10, wherein:
each of the plurality of power transmission resonant circuits is a parallel resonant circuit in which the primary capacitor is connected in parallel to the primary coil; and
the power reception resonant circuit is a series resonant circuit in which the secondary capacitor is connected in series to the secondary coil.

14. The wireless power supply system according to claim 10, wherein:
the primary capacitor includes a parallel primary capacitor connected in parallel to the primary coil and a series primary capacitor connected in series to the primary coil;
each of the plurality of power transmission resonant circuit is a resonant circuit configured by the primary coil, the parallel primary capacitor, and the series primary capacitor; and
the power reception resonant circuit is a series resonant circuit in which the secondary capacitor is connected in series to the secondary coil.

15. A wireless power supply system including the coil group according to claim 9, the wireless power supply system comprising:
a plurality of power transmission resonant circuits corresponding to the plurality of primary coils;
a power reception resonant circuit having the secondary coil and a secondary capacitor; and
a power storage apparatus that stores power received by the secondary coil, wherein
each of the plurality of power transmission resonant circuits includes (i) a series resonant circuit having a corresponding primary coil of the plurality of primary coils and a capacitor connected in series to the primary coil, and (ii) a coupling circuit having a tertiary coil that is able to be magnetically coupled with the primary coil and a tertiary capacitor connected in parallel to the tertiary coil, and the power reception resonant circuit is a series resonant circuit in which the secondary capacitor is connected in series to the secondary coil, and
each of the plurality of power transmission resonant circuits and the power reception resonant circuit are configured such that a coupling coefficient between the tertiary coil and the secondary coil, and power output to the power storage apparatus have a positive correlation.

16. A wireless power supply system including the coil group according to claim 9, the wireless power supply system comprising:
a plurality of power transmission resonant circuits corresponding to the plurality of primary coils;
a power reception resonant circuit having the secondary coil and a secondary capacitor; and
a power storage apparatus that stores power received by the secondary coil, wherein
each of the plurality of power transmission resonant circuits includes a corresponding primary coil of the plurality of primary coils, a primary capacitor connected in series to the primary coil, a tertiary coil that is able to be magnetically connected with the primary coil and connected in series to the primary coil, and a tertiary capacitor connected in parallel to the tertiary coil,
the power reception resonant circuit is a series resonant circuit in which the secondary capacitor is connected in series to the secondary coil, and
each of the plurality of power transmission resonant circuits and the power reception resonant circuit are configured such that a coupling coefficient between the tertiary coil and the secondary coil, and power output to the power storage apparatus have a positive correlation.

17. The wireless power supply system according to claim 10, further comprising:
an alternating-current power supply that supplies alternating-current power at an operating frequency prescribed in advance to the plurality of power transmission resonant circuits, wherein
each of the plurality of power transmission resonant circuits is a series resonant circuit in which the primary capacitor is connected in series to the primary coil,
the power reception resonant circuit is a series resonant circuit in which the secondary capacitor is connected in series to the secondary coil, and
when self-inductance of the primary coil is L1, a capacitance value of the primary capacitor is C1, self-inductance of the secondary coil is L2, a capacitance value of the secondary capacitor is C2, a coupling coefficient between the primary coil and the secondary coil is k, and an angular frequency of the alternating-current power is ω,
the capacitance value C1 satisfies expression (4), below, and the capacitance value C2 satisfies expression (5), below.
$$C 1 = 1 / ( ω 2 \times L 1 \times ( 1 + k ) ) \qquad ( 4 )$$
$$C 2 = 1 / ( ω 2 \times L 2 \times ( 1 + k ) ) \qquad ( 5 )$$
